(19) United States
(12) Patent Application Publication
(10) Pub. No.: US 2024/0411440 A1
(43) Pub. Date: Dec. 12, 2024

(54) INFORMATION PROCESSING DEVICE AND NON-TRANSITORY COMPUTER READABLE MEDIUM STORING PROGRAM

(71) Applicant: SUMITOMO HEAVY INDUSTRIES, LTD., Tokyo (JP)

(72) Inventor: Masanobu NAKAZONO, Kanagawa (JP)

(21) Appl. No.: 18/650,232

(22) Filed: Apr. 30, 2024

(30) Foreign Application Priority Data
Jun. 9, 2023 (JP) 2023-095660

(51) Int. Cl. G06F 3/04847; B29C 45/76

(52) U.S. Cl. CPC G06F 3/04847; B29C 45/766

(57) ABSTRACT

An information processing device includes: a display control unit that displays on a display device an input screen for inputting information related to a quality of a molding product manufactured by an injection molding machine; a receiving unit that receives an operation performed on the input screen; and a generation unit that generates the information related to the quality of the molding product according to the operation received by the receiving unit, in which the input screen is a screen that includes a predetermined item, which is the information related to the quality of the molding product and that displays a content for each item in a graph, and on the input screen, the content displayed in the graph is changed according to the operation received by the receiving unit.

### CROSS-REFERENCE TO RELATED APPLICATIONS

This application claims priority to Japanese Patent Application No. 2023-095660, filed on Jun. 9, 2023, which is incorporated by reference herein in its entirety.

### BACKGROUND

### Technical Field

A certain embodiment relates to an information processing device and a non-transitory computer readable medium storing a program.

### Description of Related Art

An injection molding machine manufactures a molding product by performing injection molding according to set molding conditions. There are various related techniques for optimizing the molding conditions of the injection molding machine. For example, there is a technique of inputting information on the quality of the manufactured molding product and estimating the molding conditions required to obtain the input molding quality by using machine learning.

The related art discloses an injection molding system including: a reward calculation unit that calculates a reward based on physical quantity data obtained by performing injection molding and on a reward condition set in advance; an operation condition adjustment learning unit that performs machine learning to adjust an operation condition including a molding condition based on the reward calculated by the reward calculation unit, an operation condition adjustment, and the physical quantity data; and an operation condition adjustment amount output unit that determines and outputs an operation condition adjustment target and an adjustment amount based on the machine learning performed by the operation condition adjustment learning unit.

The related art discloses a device, which is a manipulated variable determination device that determines a manipulated variable related to a molding machine, that generates a state representation map representing a state of the molding machine based on observation data obtained by observing a physical quantity related to molding when the molding machine executes molding and that outputs the manipulated variable based on the state representation map.

### SUMMARY

According to an embodiment of the present invention, there is provided an information processing device including: a display control unit that displays on a display device an input screen for inputting information related to a quality of a molding product manufactured by an injection molding machine; a receiving unit that receives an operation performed on the input screen; and a generation unit that generates the information related to the quality of the molding product according to the operation received by the receiving unit, in which the input screen is a screen that includes a predetermined item, which is the information related to the quality of the molding product and that displays a content for each item in a graph, and on the input screen, the content displayed in the graph is changed according to the operation received by the receiving unit.

### BRIEF DESCRIPTION OF THE DRAWINGS

FIG. 1 is a diagram showing a configuration of an injection molding machine to which the present embodiment is applied.

FIG. 2 is a diagram showing a configuration of a control device.

FIG. 3 is a diagram showing a configuration of a data processing device.

FIG. 4 is a diagram showing a hardware configuration example of the control device and the data processing device.

FIG. 5 is a diagram showing a configuration example of an input screen used when a molding quality is specified.

FIG. 6 is a diagram showing a modification example of an input screen using a radar chart.

FIG. 7 is a diagram showing another modification example of an input screen using a radar chart.

FIG. 8 is a diagram showing another configuration example of an input screen used when the molding quality is specified.

FIG. 9 is a diagram showing a modification example of an input screen using a bar graph.

FIG. 10 is a diagram showing another modification example of an input screen using a bar graph.

FIG. 11 is a diagram showing a configuration example of an input screen for receiving character input.

FIG. 12 is a diagram showing another configuration example of an input screen for receiving character input.

### DETAILED DESCRIPTION

When the molding condition is estimated by using the data obtained by executing the injection molding, costs are incurred to provide an inspection device for acquiring data or to perform an analysis process on the data in association with the execution of the injection molding. In addition, it is conceivable that a user manually inputs a result of a functional evaluation by visual observation or a measurement value obtained by using a measuring instrument such as a micrometer with respect to a molding product. However, such a method requires a lot of input work and is a burden on the user.

It is desirable to provide a user interface that reduces a burden on a user in input work of information related to a quality of a molding product.

Hereinafter, embodiments of the present invention will be described in detail with reference to the accompanying drawings.

### Device Configuration

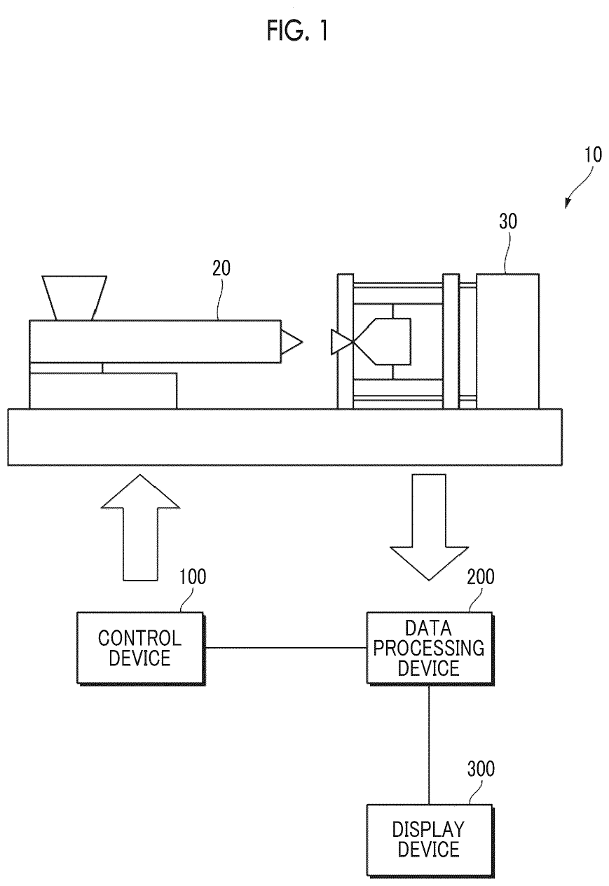

FIG. 1 is a diagram showing a configuration of an injection molding machine to which the present embodiment is applied. The injection molding machine 10 includes an injection unit 20, a mold clamping unit 30, a control device 100, a data processing device 200, and a display device 300.

The injection unit 20 is configured to include a cylinder that heats a molding material, a screw that is rotatable in the cylinder and that is provided to be able to advance and retreat in an axial direction, a rotary motor that drives the screw in a rotation direction, a motor that drives the screw in the axial direction, and the like. The molding material is, for example, a resin. The injection unit 20 injects the molding material, which is heated and liquefied in the cylinder, by advancing the screw in a direction (front) toward the mold clamping unit 30 from the injection unit 20 while rotating the screw and fills a die of the mold clamping unit 30, which is disposed in front of the injection unit 20, with the molding material. The injection unit 20 performs, for example, a plasticizing process, a filling process, a pressure holding process, or the like in a manufacturing process of a molding product. The filling process and the pressure holding process may be collectively referred to as an injection process.

The mold clamping unit 30 is configured to include a die, a clamping mechanism that clamps the die, and a motor that drives the clamping mechanism. The mold clamping unit 30 closes the die to receive the molding material, which is injected from the injection unit 20, into the die. In this case, the mold clamping unit 30 clamps the die with the clamping mechanism such that the die does not open as the die is filled with the molding material (mold clamping). A molding product is produced by solidifying the molding material that fills the die. After this, the mold clamping unit 30 opens the die to feed out the produced molding product. The mold clamping unit 30 performs, for example, a mold closing process, a pressurizing process, a mold clamping process, a depressurizing process, a mold opening process, or the like in the manufacturing process of the molding product.

The control device 100 is a device that controls operations of the injection unit 20 and the mold clamping unit 30. The data processing device 200 is a device that processes data obtained as the injection unit 20 and the mold clamping unit 30 are operated. In addition, the data processing device 200 generates an input screen for receiving input of information from a user and processes the data received through the input screen. The display device 300 displays information related to control of the injection unit 20 and the mold clamping unit 30 by the control device 100, data acquired by the data processing device 200, a processing result of the data processing device 200, or the like. In addition, the display device 300 displays an input screen for performing an operation of inputting a command or data to the control device 100 or the data processing device 200, other operation screens, a screen for presenting information to the user, or the like.

### Configuration of Control Device 100

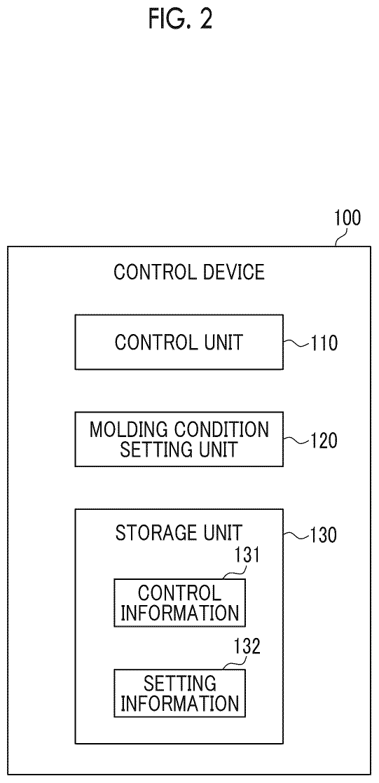

FIG. 2 is a diagram showing a configuration of the control device 100. The control device 100 controls the operations of the injection unit 20 and the mold clamping unit 30. The control device 100 is implemented by, for example, a computer. The control device 100 includes a control unit 110, a molding condition setting unit 120, and a storage unit 130. The control device 100 controls the injection unit 20 and the mold clamping unit 30 to repeatedly perform processes related to the manufacture of the molding product, thereby repeatedly manufacturing the molding product. The process related to the manufacture of the molding product includes a plasticizing process, a mold closing process, a pressurizing process, a mold clamping process, a filling process, a pressure holding process, a cooling process, a depressurizing process, a mold opening process, an ejection process, and the like. Hereinafter, these processes related to the manufacture may be collectively referred to as a “manufacturing process”. In addition, a series of operations for obtaining the molding product, for example, an operation from a start of the plasticizing process to a start of the next plasticizing process in the above manufacturing process is referred to as a “shot” or a “molding cycle”. Each of the above-described processes for manufacturing the molding product is merely an example. For example, as a process executed in one shot, another process, which is not included in the above, may be included.

The control unit 110 controls the injection unit 20 and the mold clamping unit 30 based on control information. The control information is a condition set by the user and is generated based on the information input from the user using, for example, an input device (not shown). For example, the control information includes molding conditions such as resin temperature, die temperature (cylinder temperature), injection pressure holding time, metering value, V-P switching position, holding pressure, injection speed (filling speed), screw rotating speed, screw back pressure, and mold clamping force. A plurality of combinations of these molding conditions are determined according to the molding product or the die. Hereinafter, combination data of the molding conditions will be also referred to as a molding condition data set. The molding condition data set is prepared in accordance with the type of the molding product or the die and is stored in the storage unit 130.

The control unit 110 controls the injection unit 20 and the mold clamping unit 30 by using the above-described molding condition data set and performs a process related to the manufacture (shot) of the molding product that includes each of the above-described processes. The control unit 110 reads the molding condition data set corresponding to the molding product to be manufactured from the storage unit 130, for example, when the manufacture of the molding product starts. The control unit 110 controls the operations of the injection unit 20 and the mold clamping unit 30 based on the control information including the read molding condition data set. Specifically, the control unit 110 controls the injection unit 20 and the mold clamping unit 30 such that the data, which is obtained from the injection unit 20 and the mold clamping unit 30 in the manufacturing process, matches a set value of the molding condition data set. In addition, the control unit 110 may display the molding condition data set, which is read from the storage unit 130, on the display device 300. The user may refer to the data of the molding condition, which is displayed on the display device 300, and may perform an operation of correcting a value or the like as necessary.

The molding condition setting unit 120 sets the molding condition that is used in the control of the injection unit 20 and the mold clamping unit 30 by the control unit 110. The setting of the molding condition is performed by the molding condition setting unit 120 writing the molding condition data set in the control information stored in the storage unit 130. In addition, the setting of the molding condition is performed based on the information input from the user through an input screen to be described later. When the manufacturing process of the molding product is repeated, states of the injection unit 20 and the mold clamping unit 30 are changed, and state changes of the injection unit 20 and the mold clamping unit 30 affect a quality of the molding product (hereinafter, referred to as a “molding quality”). Therefore, in order to maintain the molding quality in the operation when mass production of the molding products is performed, the molding condition setting unit 120 may automatically adjust the molding condition.

The storage unit 130 stores the control information 131 used for controlling the injection unit 20 and the mold clamping unit 30 by the control unit 110. The control information 131 includes the molding condition data set that is set by the molding condition setting unit 120. The molding condition data set is prepared to be associated with the molding product to be manufactured or the die. The storage unit 130 stores the molding condition data set for each molding product to be manufactured or the die. In addition, the storage unit 130 stores the information (hereinafter, referred to as “setting information”) 132 on the molding condition generated by the input from the user. The molding condition setting unit 120 writes the molding condition data set in the control information 131 based on the setting information 132.

In addition, although not shown, the storage unit 130 stores a program for the control unit 110 to control the injection unit 20 and the mold clamping unit 30 and a program for the molding condition setting unit 120 to set the molding condition. As will be described in detail later, functions of the control unit 110 and the molding condition setting unit 120 are implemented by a processor of the control device 100 reading and executing the program stored in the storage unit 130.

### Configuration of Data Processing Device 200

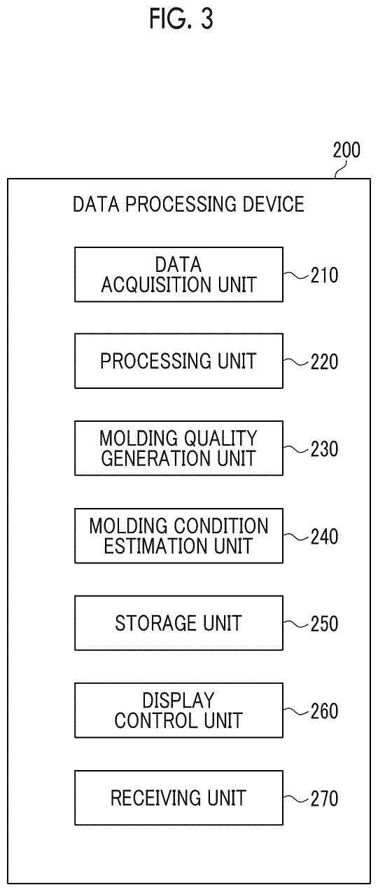

FIG. 3 is a diagram showing a configuration of the data processing device 200. The data processing device 200 acquires and processes data obtained as the injection unit 20 and the mold clamping unit 30 execute operations in a process related to the manufacture of the molding product. In addition, the data processing device 200 generates the information (the setting information 132), which is used for the molding condition setting unit 120 of the control device 100 to set the molding condition in response to the operation of the user, and transmits the information to the control device 100. The data processing device 200 is implemented by, for example, a computer. The data processing device 200 includes a data acquisition unit 210, a processing unit 220, a molding quality generation unit 230, a molding condition estimation unit 240, a storage unit 250, a display control unit 260, and a receiving unit 270.

The data processing device 200 of the present embodiment receives the operation, which is performed on the input screen, from the user, generates targeted molding quality data, and estimates the molding condition required to obtain a targeted molding quality based on the molding quality data. The data processing device 200 transmits the estimated molding condition to the control device 100, and the control device 100 stores the received molding condition in the storage unit 130 as the setting information 132. The targeted molding quality is a molding quality in which the molding product is determined to be a non-defective product.

The data acquisition unit 210 acquires data to be processed from the injection unit 20 and the mold clamping unit 30. Various sensors, detectors, and the like are attached to the injection unit 20 and the mold clamping unit 30. In addition, various types of measuring equipment may be connected to the injection unit 20 or the mold clamping unit 30. The data (hereinafter, referred to as “acquisition data”), which is acquired by using these sensors, detectors, and measuring equipment, is information representing a molding result obtained by the injection unit 20 and the mold clamping unit 30 and is used for quality management of the molding product. Specifically, for example, a weight of the molding product, a dimension of the molding product, a mold internal pressure, a minimum cushion position, a feature amount of waveforms of a filling pressure, and the like are included. The acquisition data is an actual value obtained in the manufacturing process of the molding product. The data acquisition unit 210 receives the acquisition data, which is transmitted from the sensor, the detector, or the measuring equipment, and stores the acquisition data in the storage unit 250. The data acquisition unit 210 is an example of a receiving unit.

The processing unit 220 processes the acquisition data stored in the storage unit 250. Specifically, the processing unit 220 performs a process such as extracting a representative value of the acquisition data obtained in each process and generating time-series data in which time series is associated with the acquisition data obtained in each process. In extracting the representative value, the processing unit 220 performs a statistical process such as calculating an average value, specifying a possible range of values, and specifying a maximum value or a minimum value with respect to the acquisition data.

The molding quality generation unit 230 generates the molding quality data in response to the operation on the input screen by the user. The user manipulates an image representing the molding quality information on the input screen that is a graphical user interface (GUI). Accordingly, the molding quality generation unit 230 generates the molding quality data reflecting an operation content on the input screen. More specifically, data is calculated, which represents a difference between the molding quality in the manufactured molding product and the targeted molding quality. The molding quality data to be generated is data of an item, which is displayed as an operation target on the input screen, among data representing the molding quality such as the weight of the molding product, the dimension of the molding product, the mold internal pressure, the minimum cushion position, and the feature amount of waveforms of the filling pressure. Details of the input screen, an operation method of the input screen, a generation method of the molding quality, and the like will be described later. The molding quality generation unit 230 is an example of a generation unit.

The molding condition estimation unit 240 estimates the molding condition required to obtain the molding quality based on the molding quality data generated by the molding quality generation unit 230. That is, the difference between the molding quality that is input on the input screen and the targeted molding quality is embedded, and the molding condition that is required to obtain the targeted molding quality is calculated. The estimation of the molding condition is performed by using a known estimation method corresponding to a multivariate input and output. For example, the molding condition can be estimated from the molding quality by using the molding condition that is used in actual manufacturing in the past and by using a mathematical model that is trained in advance through machine learning or the like using the actual value of the molding quality of the molding product manufactured under the molding condition and that represents a relationship between the molding quality and the molding condition. The molding condition estimation unit 240 is an example of an estimation unit.

The storage unit 250 stores the acquisition data that is acquired by the data acquisition unit 210. As a data format of the acquisition data stored in the storage unit 250, for example, binary, text, comma-separated values (CSV), INI, YAML Ain't Markup Language (YAML), JavaScript Object Notation (JSON), or the like may be used. By creating data files in these general-purpose data formats, a data file that is stored in the storage unit 250 can be data-exchanged with other information processing devices, and a data file that is acquired from an external device can be edited. In addition, the storage unit 250 may store the molding quality data that is generated by the molding quality generation unit 230 and the molding condition data that is estimated by the molding condition estimation unit 240.

In addition, although not shown, the storage unit 250 stores a program for the processing unit 220, the molding quality generation unit 230, and the molding condition estimation unit 240 to execute a data process, a program for the display control unit 260 to display a screen on the display device 300, and a program for the receiving unit 270 to receive the operation of the user performed on the operation screen. As will be described in detail later, when the processor in the data processing device 200 reads and executes the program stored in the storage unit 250, the functions of the processing unit 220, molding quality generation unit 230, molding condition estimation unit 240, display control unit 260, and receiving unit 270 are implemented.

The display control unit 260 generates the operation screen for the user to perform various operations and displays the operation screen on the display device 300. As an example, the display control unit 260 displays the input screen for the user to input the molding condition. The receiving unit 270 receives operations performed by the user on the operation screen displayed on the display device 300. Specifically, for example, a data input that is performed on an input field of the input screen, a switching operation of the screen, or the like are received.

### Hardware Configuration of Control Device 100 and Data Processing Device 200

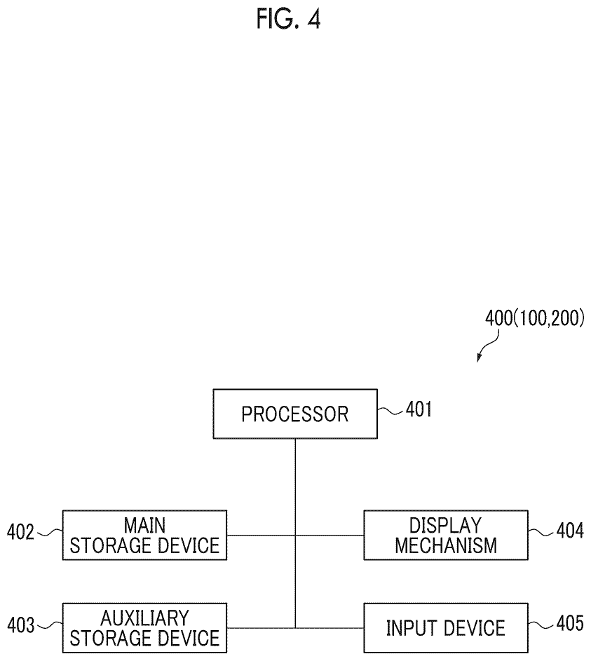

FIG. 4 is a diagram showing a hardware configuration example of a computer 400 that implements the control device 100 and the data processing device 200. The computer 400 shown in FIG. 4 includes a processor 401 as a calculation unit, and a main storage device (a main memory) 402 and an auxiliary storage device 403 as storage units. For example, as the processor 401, a central processing unit (CPU), a graphics processing unit (GPU), an application-specific integrated circuit (ASIC), a field-programmable gate array (FPGA), or various other calculation circuits can be used. The processor 401 reads a program, which is stored in the auxiliary storage device 403, into the main storage device 402 and executes the program. For example, a random-access memory (RAM) is used as the main storage device 402. For example, a magnetic disk device, a solid-state drive (SSD), or the like is used as the auxiliary storage device 403. In addition, the computer 400 includes a display mechanism 404 for displaying an image on the display device (a display) 300 and an input device 405 as an input unit through which an input operation is performed by a user of the computer. For example, a keyboard, a mouse, a touch panel, or the like is used as the input device 405. In addition, the configuration of the computer 400 shown in FIG. 4 is merely an example, and the computer 400 that is used in the present embodiment is not limited to the configuration example in FIG. 4. For example, a non-volatile memory such as a flash memory or a read-only memory (ROM) may be provided as the storage device.

When the control device 100 is implemented by the computer shown in FIG. 4, the functions of the control unit 110 and the molding condition setting unit 120 are implemented, for example, by the processor 401 reading and executing the program. For example, the storage unit 130 is implemented by the auxiliary storage device 403.

When the data processing device 200 is implemented by the computer shown in FIG. 4, the functions of the data acquisition unit 210, the processing unit 220, the molding quality generation unit 230, and the molding condition estimation unit 240 are implemented, for example, by the processor 401 reading and executing the program. For example, the storage unit 250 is implemented by the auxiliary storage device 403. The display control unit 260 is implemented by, for example, the processor 401, which reads and executes the program, and the display mechanism 404. The receiving unit 270 is implemented by, for example, the processor 401, which reads and executes the program, and the input device 405.

### Input of Molding Quality for Setting Molding Condition

Next, a method of setting the molding condition according to the present embodiment will be described. A case where the user sets a new molding condition will be considered. Examples of situations in which a molding condition is newly set include a case where a condition is set to improve the molding quality, and a case where a molding condition for manufacturing a new molding product is set. In such a case, when the user has little experience in manufacturing a molding product using the injection molding machine, it may be difficult to determine which item of the molding condition is to be set and in what manner. However, even a user with little experience may be able to specify a required molding quality. Therefore, in the present embodiment, the input of the molding quality information from the user is received, the necessary molding condition is estimated from the input molding quality information, and the estimated molding condition is used in the control device 100 to control the injection unit 20 and the mold clamping unit 30.

In addition, in the present embodiment, a graphical user interface is provided for inputting the molding quality information. As will be described in detail later, in the present embodiment, an image representing the content of the molding quality is displayed on the input screen displayed on the display device 300, and a manipulation of the image is received. The user specifies a desired molding quality by manipulating the image. By adopting such an interface, it is possible to reduce a burden on the user when the molding quality information is input.

### Configuration Example of Input Screen

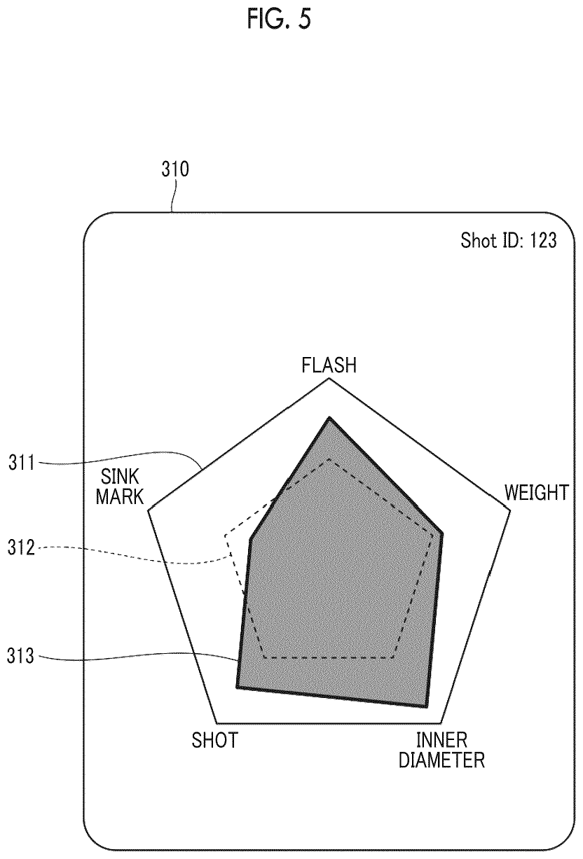

FIG. 5 is a diagram showing a configuration example of an input screen used when the molding quality is specified. An input screen 310 is displayed on the display device 300 under the control of the display control unit 260 of the data processing device 200. A graph 311, which represents the molding quality, is displayed on the input screen 310 together with shot identification information. In the example shown in FIG. 5, a radar chart is used as the graph 311. Hereinafter, a radar chart as an example of the graph 311 will also be described with the same reference numeral 311 attached thereto. In the example shown in FIG. 5, the shot identification information is displayed as “Shot ID: 123” in an upper right corner of the input screen 310.

The radar chart 311 shown in FIG. 5 is a pentagon chart having five items of “flash”, “sink mark”, “shot”, “inner diameter”, and “weight” as items representing the molding quality. The “flash”, “sink mark”, and “shot” are types of defects in the molding product and are qualitative indexes. The “inner diameter” and “weight” are elements indicating a state of the molding product and are quantitative indexes. In addition, the items of the radar chart 311 shown in FIG. 5 are merely examples, and the information representing the molding quality is not limited to the shown items. As the items of the radar chart 311, in addition to the shown items, information which represents various molding qualities such as the dimension of the molding product, the mold internal pressure, the minimum cushion position, and the feature amount of waveforms of the filling pressure can be used according to the molding product to be manufactured, the type of die, the specification of the injection molding machine 10, or the like.

A reference line 312 and a quality image 313 are displayed on the radar chart 311. The reference line 312 is an image indicating a reference (hereinafter, referred to as a “non-defective product reference”) at which the molding product is determined to be a non-defective product in each item of the molding quality. The content of the reference is individually set for each item. In the example shown in FIG. 5, the non-defective product reference for each item is set at an equal distance from a center of the radar chart 311, and the pentagon reference line 312 of a broken line connecting the non-defective product references for each item is displayed. The molding quality, which is indicated by the reference line 312, is the targeted molding quality for the molding product to be manufactured. The user can input the molding quality of the obtained molding product, based on the reference line 312.

The quality image 313 is an image representing the input molding quality. In the example shown in FIG. 5, the pentagon quality image 313 in which the content of the molding quality for each item is represented with the distance from the center of the radar chart 311 is displayed. For example, when a mouse is used as the input device 405, the user can change the content of the molding quality to be input by selecting and dragging a vertex corresponding to a desired item of the quality image 313 with a mouse operation. In addition, when a touch panel is used as the input device 405, the user can change the content of the molding quality to be input by touching and sliding a vertex corresponding to a desired item of the quality image 313 with a finger.

The radar chart 311 is created based on actual data obtained by actually manufacturing the molding product. The molding quality information for each item is input from the user. The user evaluates the molding quality for each item in the molding product by observing the manufactured molding product or by measuring the molding product with measuring equipment. The input device 405 is operated based on the evaluation result to create the quality image 313. In addition, depending on the type of the item indicated by the radar chart 311, the quality image 313 may be created based on the information obtained from a sensor or a detector provided in the injection unit 20 and the mold clamping unit 30 without depending on the operation of the user.

When the quality image 313 is specified by the operation of the user using the input screen 310 as shown in FIG. 5, the molding quality generation unit 230 of the data processing device 200 generates data representing a difference between the molding quality indicated by the quality image 313 and the targeted molding quality indicated by the reference line 312. The molding condition estimation unit 240 estimates the molding condition required to obtain the targeted molding quality based on the data of the difference of the generated molding qualities. The data processing device 200 transmits the molding condition, which is estimated by the molding condition estimation unit 240, to the control device 100. The control device 100 stores the received molding condition in the storage unit 130 as the setting information 132, and the molding condition setting unit 120 sets the molding condition as a molding condition used for the control of the control unit 110.

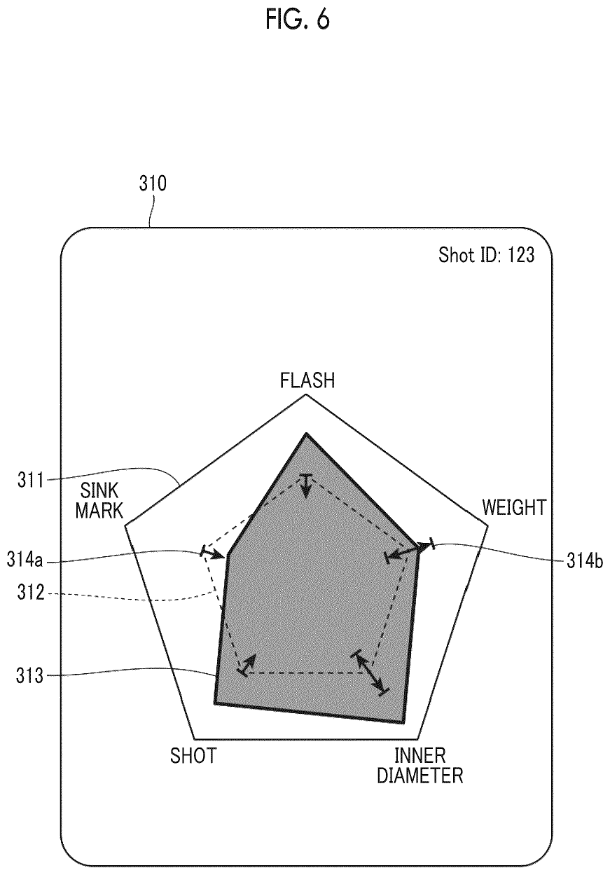

FIG. 6 is a diagram showing a modification example of the input screen 310 using the radar chart 311. In the radar chart 311 shown in FIG. 6, in the operation of the radar chart 311 by the user, a suggestion image 314 (314a, 314b) for suggesting the molding quality in which the molding product is determined to be a non-defective product is displayed. The reference line 312 and the suggestion image 314 shown in the radar chart 311 are examples of the reference images.

The items representing the molding quality include an item for which a boundary between a non-defective product and a defective product for the molding product is specified and an item for which a range where the molding product is determined to be a non-defective product is specified. For the former item, a suggestion image 314a indicating the boundary between a non-defective product and a defective product is displayed, and for the latter item, a suggestion image 314b indicating the range where the molding product is determined to be a non-defective product is displayed.

In the example shown in FIG. 6, among the five items representing the molding quality, “flash”, “sink mark”, and “shot” are the items for which the boundary between a non-defective product and a defective product is specified, and the suggestion image 314a indicating the boundary between the non-defective product and the defective product is displayed. The suggestion image 314a is an image including a line segment indicating a boundary and an arrow indicating a side where the molding product is determined to be a non-defective product. In the example shown in FIG. 6, in the suggestion image 314a, a line segment is disposed at a position of a vertex corresponding to each item of the reference line 312, and an arrow pointing toward an inner side (the center direction of the radar chart 311) from the line segment is displayed.

In the example shown in FIG. 6, when the quality image 313 is referred to, since the “sink mark” is on the side (the inner side) where the arrow points with respect to the boundary indicated by the suggestion image 314a, the content indicates that the molding product is determined to be a non-defective product. On the other hand, since the “flash” and “shot” are on a side opposite (an outer side) to the arrow with respect to the boundary indicated by the suggestion image 314a, the content indicates that the molding product is determined to be a defective product. Therefore, the molding quality generation unit 230 generates data representing a difference between the quality image 313 and the reference line 312, regarding at least the “flash” and “shot”. The molding condition estimation unit 240 estimates a condition under which a better quality equal to or higher than the difference indicated by the data generated by the molding quality generation unit 230 is obtained, regarding the item of the molding condition that causes at least “flash” and “shot”. This means that in the radar chart 311 shown in FIG. 6, each of the items of “flash”, “sink mark”, and “shot”, which are qualitative indexes, is on the inner side of the reference line 312 as shown in the suggestion image 314a, and the molding condition in which the item is closer to the center is estimated.

In addition, among the five items representing the molding quality in the radar chart 311 shown in FIG. 6, the “inner diameter” and “weight” are items for which the range where the molding product is determined to be a non-defective product is specified, and the suggestion image 314b indicating the range where the molding product is determined to be a non-defective product is displayed. The suggestion image 314b is an image including two parallel line segments indicating a range and a bidirectional arrow pointing to each line segment between the two line segments. In the example shown in FIG. 6, the suggestion image 314b is displayed such that the suggestion image 314b straddles the vertices corresponding to each item of the reference line 312, and the bidirectional arrow runs along a direction from each vertex toward the center of the radar chart 311.

In the example shown in FIG. 6, when the quality image 313 is referred to, since the “weight” is within the range indicated by the suggestion image 314b, the content indicates that the molding product is determined to be a non-defective product. On the other hand, since the “inner diameter” is outside the range indicated by the suggestion image 314b, the content indicates that the molding product is determined to be a defective product. Therefore, the molding quality generation unit 230 generates the data representing the difference between the quality image 313 and the reference line 312, regarding at least the “inner diameter”. The molding condition estimation unit 240 estimates a condition for eliminating the difference indicated by the data generated by the molding quality generation unit 230, regarding the item of the molding condition that affects at least the “inner diameter”. This means that in FIG. 6, the molding condition is estimated such that each of the items of the “weight” and “inner diameter”, which are quantitative indexes, is within the range indicated by the suggestion image 314b.

In the example shown in FIG. 6, although the item for which the molding product is determined to be a non-defective product and the item for which the molding product is determined to be a defective product are not distinguished from each other in the radar chart 311, the items may be displayed in an identifiable manner. Specifically, for example, display of the item (in the illustrated example, display of the “sink mark” and “weight”) for which the molding product is determined to be a non-defective product and display of the item (in the illustrated example, display of the “flash”, “shot”, and “inner diameter”) for which the molding product is determined to be a defective product can be displayed with different display modes such as display colors or display fonts. In this way, the user can visually and easily discriminate the item for which the molding quality is to be changed in the radar chart 311.

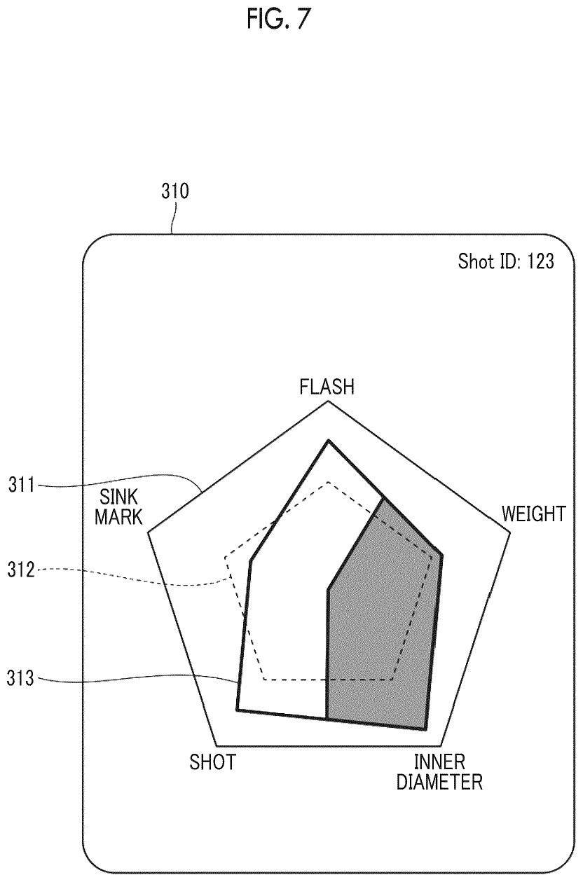

FIG. 7 is a diagram showing another modification example of the input screen 310 using the radar chart 311. In the radar chart 311 shown in FIG. 7, among five items representing the molding quality, the items (“flash”, “sink mark”, and “shot”) for which the boundary between a non-defective product and a defective product is specified and the items (“inner diameter” and “weight”) for which the range where the molding product is determined to be a non-defective product is specified are displayed in a distinguishable manner. In the example shown in FIG. 7, in the quality image 313, a region which includes the item for which the boundary between a non-defective product and a defective product is specified is displayed in white, and a region which includes the item for which the range where the molding product is determined to be a non-defective product is specified is displayed in a mesh pattern. In this way, in the radar chart 311, the user can visually and easily discriminate between the item for which the boundary between a non-defective product and a defective product is specified and the item for which the range where the molding product is determined to be a non-defective product is specified.

### Other Configuration Example of Input Screen

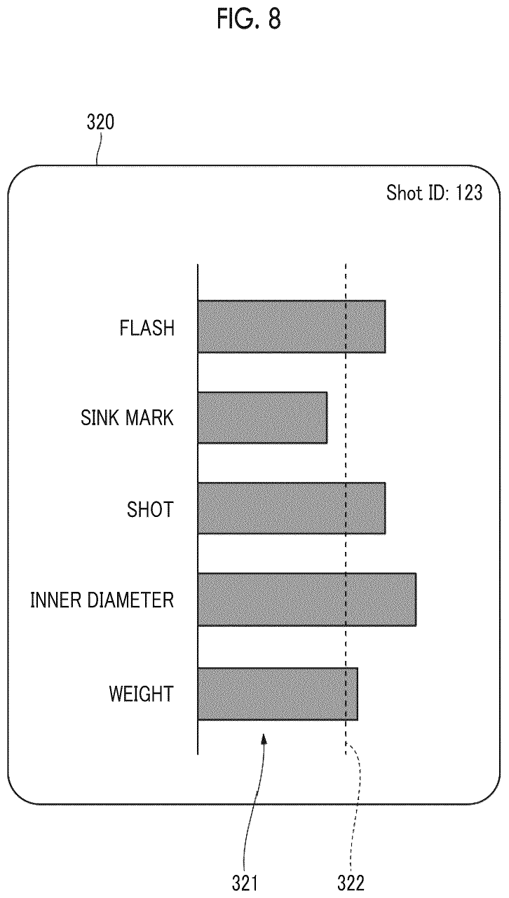

FIG. 8 is a diagram showing another configuration example of the input screen used when the molding quality is specified. An input screen 320 is displayed on the display device 300 under the control of the display control unit 260 of the data processing device 200. A graph 321, which represents the molding quality, is displayed on the input screen 320 together with shot identification information. In the example shown in FIG. 8, a bar graph is used as the graph 321. Hereinafter, the bar graph as an example of the graph 321 will also be described with the same reference numeral 321 attached thereto. In the example shown in FIG. 8, the shot identification information is displayed as “Shot ID: 123” in an upper right corner of the input screen 320.

The bar graph 321 shown in FIG. 8 is a graph having five items of “flash”, “sink mark”, “shot”, “inner diameter”, and “weight” as items representing the molding quality. The “flash”, “sink mark”, and “shot” are types of defects in the molding product. The “inner diameter” and “weight” are elements indicating the state of the molding product. In addition, the items of the bar graph 321 shown in FIG. 8 are merely examples, and the information representing the molding quality is not limited to the items illustrated. As the items of the bar graph 321, in addition to the shown items, information which represents various molding qualities such as the dimension of the molding product, the mold internal pressure, the minimum cushion position, and the feature amount of waveforms of the filling pressure can be used according to the molding product to be manufactured, the type of die, the specification of the injection molding machine 10, or the like.

A reference line 322 is displayed in the bar graph 321. The reference line 322 is an image indicating a reference (hereinafter, referred to as a “non-defective product reference”) at which the molding product is determined to be a non-defective product in each item of the molding quality. The content of the reference is individually set for each item. In the example shown in FIG. 8, the non-defective product reference for each item is set at an equal distance from an origin (a left end) of the bar graph 321, and the reference line 322, which is formed of a straight line with a broken line connecting the non-defective product reference for each item, is displayed. The user can input the molding quality of the obtained molding product based on the reference line 322.

The bar graph 321 is created based on actual data obtained by actually manufacturing the molding product. The molding quality information for each item is input from the user. The user evaluates the molding quality of each item in the molding product and operates the input device 405 to create the graph. In addition, depending on the type of the item indicated by the bar graph 321, the graph may be created based on the information obtained from a sensor or a detector provided in the injection unit 20 and the mold clamping unit 30 without depending on the operation of the user.

When the graph representing the molding quality is specified by the operation of the user using the input screen 320 as shown in FIG. 8, the molding quality generation unit 230 of the data processing device 200 generates data representing a difference between the molding quality indicated by the bar graph 321 and the targeted molding quality indicated by the reference line 322. The molding condition estimation unit 240 estimates the molding condition required to obtain the targeted molding quality based on the data of the difference of the generated molding qualities. The data processing device 200 transmits the molding condition, which is estimated by the molding condition estimation unit 240, to the control device 100. The control device 100 stores the received molding condition in the storage unit 130 as the setting information 132, and the molding condition setting unit 120 sets the molding condition as a molding condition used for the control of the control unit 110.

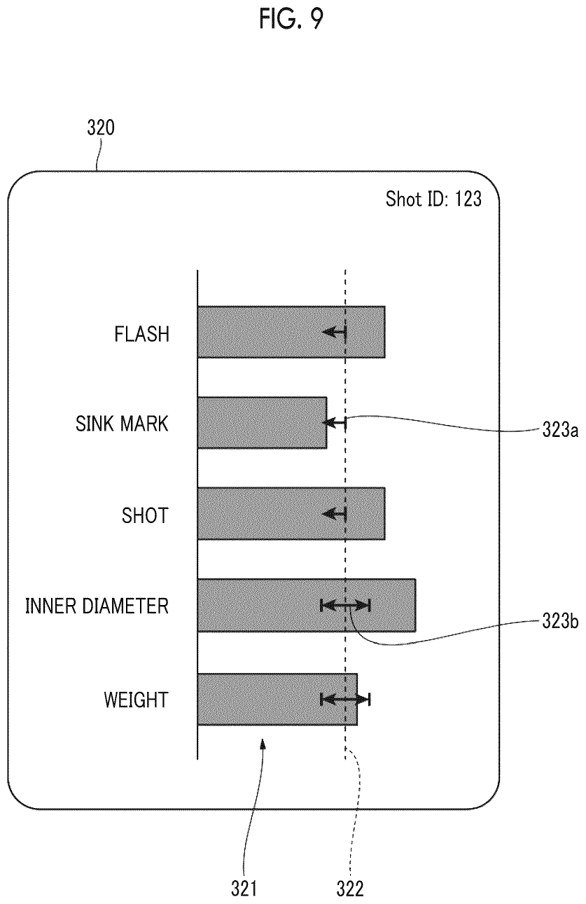

FIG. 9 is a diagram showing a modification example of the input screen 320 using the bar graph 321. In the bar graph 321 shown in FIG. 9, in the operation of the bar graph 321 by the user, a suggestion image 323 (323a, 323b) for suggesting the molding quality in which the molding product is determined to be a non-defective product is displayed. The reference line 322 and the suggestion image 323 indicated by the bar graph 321 are examples of the reference images.

The items representing the molding quality include an item for which a boundary between a non-defective product and a defective product for the molding product is specified and an item for which a range where the molding product is determined to be a non-defective product is specified. For the former item, a suggestion image 323a indicating the boundary between a non-defective product and a defective product is displayed, and for the latter item, a suggestion image 323b indicating the range where the molding product is determined to be a non-defective product is displayed.

In the example shown in FIG. 9, among the five items representing the molding quality, “flash”, “sink mark”, and “shot” are the items for which the boundary between a non-defective product and a defective product is specified, and the suggestion image 323a indicating the boundary between the non-defective product and the defective product is displayed. The suggestion image 323a is an image including a line segment indicating a boundary and an arrow indicating a side where the molding product is determined to be a non-defective product. In the example shown in FIG. 9, in the suggestion image 323a, a line segment is disposed at a position of the reference line 322 for each item, and an arrow pointing toward the origin (the left end) side of the bar graph 321 from the line segment is displayed.

In the example shown in FIG. 9, when the bar graph 321 is referred to, since the “sink mark” is on a side (a left side) where the arrow points with respect to the boundary indicated by the suggestion image 323a, the content indicates that the molding product is determined to be a non-defective product. On the other hand, since the “flash” and “shot” are on a side opposite (a right side) to the arrow with respect to the boundary indicated by the suggestion image 323a, the content indicates that the molding product is determined to be a defective product. Therefore, the molding quality generation unit 230 generates data representing a difference between the bar graph 321 and the reference line 322, regarding at least the “flash” and “shot”. The molding condition estimation unit 240 estimates a condition for eliminating the difference indicated by the data generated by the molding quality generation unit 230, regarding the item of the molding condition that causes at least “flash” and “shot”.

In addition, among the five items representing the molding quality in the bar graph 321 shown in FIG. 9, the “inner diameter” and “weight” are items for which the range where the molding product is determined to be a non-defective product is specified, and the suggestion image 323b indicating the range where the molding product is determined to be a non-defective product is displayed. The suggestion image 323b is an image including two parallel line segments indicating a range and a bidirectional arrow pointing to each line segment between the two line segments. In the example shown in FIG. 9, the suggestion image 323b is displayed such that the suggestion image 323b straddles the position of the reference line 322 for each item, and the bidirectional arrow runs along a direction where the bar graph 321 extends from each vertex.

In the example shown in FIG. 9, when the bar graph 321 is referred to, since the “weight” is within the range indicated by the suggestion image 323b, the content indicates that the molding product is determined to be a non-defective product. On the other hand, since the “inner diameter” is outside the range indicated by the suggestion image 323b, the content indicates that the molding product is determined to be a defective product. Therefore, the molding quality generation unit 230 generates the data representing the difference between the bar graph 321 and the reference line 322, regarding at least the “inner diameter”. The molding condition estimation unit 240 estimates a condition for eliminating the difference indicated by the data generated by the molding quality generation unit 230, regarding the item of the molding condition that affects at least the “inner diameter”.

In the example shown in FIG. 9, although the item for which the molding product is determined to be a non-defective product and the item for which the molding product is determined to be a defective product are not distinguished from each other in the bar graph 321, the items may be displayed in an identifiable manner. Specifically, for example, display of the item (in the illustrated example, display of the “sink mark” and “weight”) for which the molding product is determined to be a non-defective product and display of the item (in the illustrated example, display of the “flash”, “shot”, and “inner diameter”) for which the molding product is determined to be a defective product can be displayed with different display modes such as display colors or display fonts. In this way, the user can visually and easily discriminate the item for which the molding quality is to be changed in the bar graph 321.

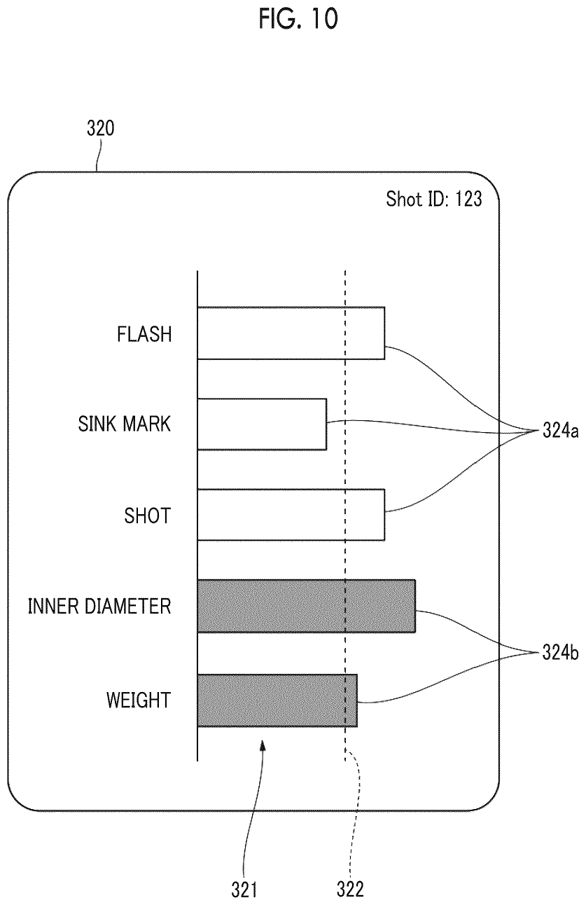

FIG. 10 is a diagram showing another modification example of the input screen 320 using the bar graph 321. In the bar graph 321 shown in FIG. 10, among five items representing the molding quality, the items (“flash”, “sink mark”, and “shot”) for which the boundary between a non-defective product and a defective product is specified and the items (“inner diameter” and “weight”) for which the range where the molding product is determined to be a non-defective product is specified are displayed in a distinguishable manner. In the example shown in FIG. 10, in the bar graph 321, a graph 324a, which includes the item for which the boundary between a non-defective product and a defective product is specified, is displayed in white, and a graph 324b, which includes the item for which the range where the molding product is determined to be a non-defective product is specified, is displayed in a mesh pattern. In this way, in the bar graph 321, the user can visually and easily discriminate between the item for which the boundary between a non-defective product and a defective product is specified and the item for which the range where the molding product is determined to be a non-defective product is specified.

Combination with Other Input Unit

The two types of input screens 310 and 320 have been described with reference to FIGS. 5 to 10. In the present embodiment, in addition to the above input screens 310 and 320, the input of the molding quality information may be received using different input units. For example, the data processing device 200 may receive a content or a value of the molding quality input by using a keyboard as the input device 405. In addition, the data processing device 200 may include a voice input unit and may receive an input of a command or a value by the user's voice.

Although the input through the GUI using the input screens 310 and 320 shown in FIGS. 5 to 10 allows intuitive operation by the user, when inputting a specific numerical value or the like, it may be easier to use character input by using a keyboard. Therefore, instead of the input screens 310 and 320, an input screen that receives character input by a keyboard may be displayed.

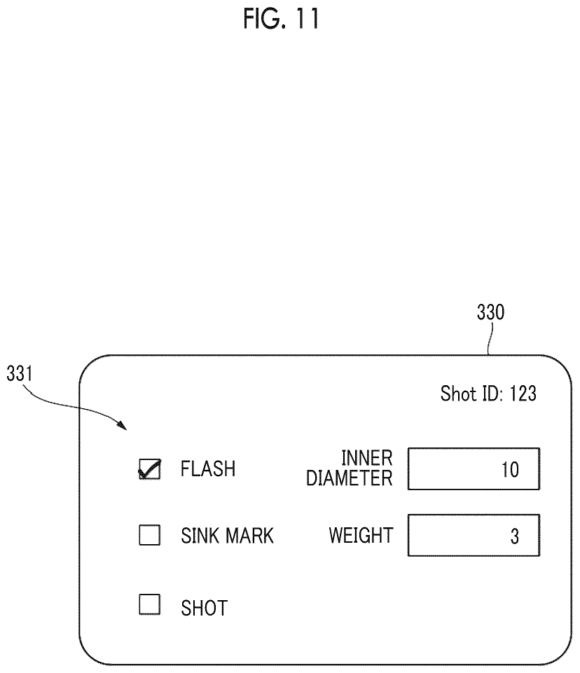

FIG. 11 is a diagram showing a configuration example of an input screen that receives character input. An input screen 330 is displayed on the display device 300 under the control of the display control unit 260 of the data processing device 200. An input field 331 for receiving input from the user and displaying the input molding quality information is displayed on the input screen 330. In addition, the shot identification information “Shot ID: 123” is displayed in an upper right corner of the input screen 330.

FIGS. 6 and 9 show that the items representing the molding quality include an item for which a boundary between a non-defective product and a defective product for the molding product is specified and an item for which a range where the molding product is determined to be a non-defective product is specified. In the former item, a non-defective product or a defective product is specified depending on the presence/absence or degree of a corresponding event. In the latter item, a non-defective product or a defective product is specified based on the numerical value representing a corresponding state of the item. In the input screen 330 shown in FIG. 11, a checkbox is provided for the former item, and a character input field for inputting a numerical value is provided for the latter item.

In the input field 331 shown in FIG. 11, as the items representing the molding quality, the five items of “flash”, “sink mark”, “shot”, “inner diameter”, and “weight”, which are similar to the input screens 310 and 320 shown in FIGS. 5 to 10, are shown. Here, the three items of “flash”, “sink mark”, and “shot” are items for which a boundary between a non-defective product and a defective product for the molding product is specified, and the two items of “inner diameter” and “weight” are items for which a range where the molding product is determined to be a non-defective product is specified. Therefore, in the input field 331 of FIG. 11, the checkboxes are provided for the three items of “flash”, “sink mark”, and “shot”, and the character input fields are provided for the two items of “inner diameter” and “weight”.

In the input screen 330 shown in FIG. 11, the checkbox of the item “flash” is checked, and it is indicated that flash is present in the molding product. In addition, the numerical value “10” is input to the character input field of the item “inner diameter”, and the numerical value “3” is input to the character input field of the item “weight”. Although only numerical values are shown in the figure, suitable units (mm, g, and the like) as the size of the molding product are set for each of the numerical values. The items of the input field 331 shown in FIG. 11 are merely examples. As the items of the input field 331, in addition to the shown items, information which represents various molding qualities such as the dimension of the molding product, the mold internal pressure, the minimum cushion position, and the feature amount of waveforms of the filling pressure can be used according to the molding product to be manufactured, the type of die, the specification of the injection molding machine 10, or the like.

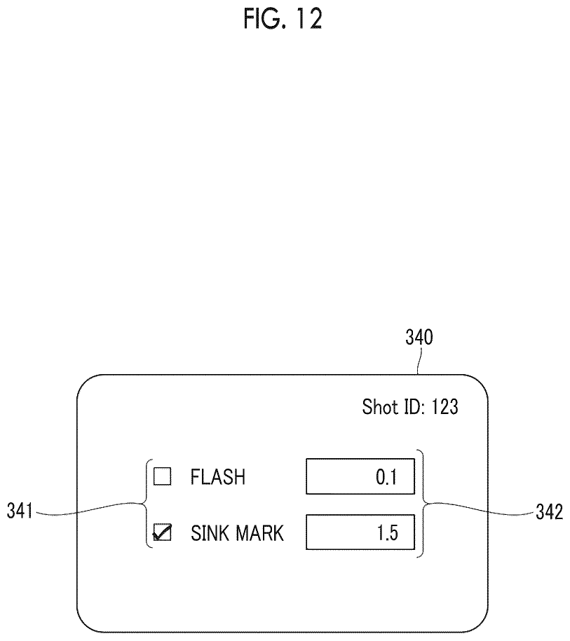

FIG. 12 is a diagram showing another configuration example of the input screen that receives character input. An input screen 340 is displayed on the display device 300 under the control of the display control unit 260 of the data processing device 200. The input screen 340 displays an item selection field 341 for designating an item of the molding quality as an input target and a character input field 342 for receiving character input by using a keyboard. In addition, the shot identification information “Shot ID: 123” is displayed in an upper right corner of the input screen 340.

In the item selection field 341 shown in FIG. 12, “sink mark” and “flash” are shown as items representing the molding quality. The user selects which item to input by checking the checkbox. In the illustrated example, the checkbox for “sink mark” is checked, and the item “sink mark” is selected. In addition, the items of the item selection field 341 shown in FIG. 12 are merely examples. As the items of the item selection field 341, in addition to the shown items, of the information which represents various molding qualities such as the dimension of the molding product, the mold internal pressure, the minimum cushion position, and the feature amount of waveforms of the filling pressure, items where input that is suitable for the character input is performed may be used as appropriate according to the molding product to be manufactured, the type of die, the specification of the injection molding machine 10, or the like.

The content, which is input to the character input field 342, may be different depending on the type of the item of the molding quality selected in the item selection field 341. In the example shown in FIG. 12, a value “1.5” representing the magnitude of the “sink mark” generated in the molding product is input. In addition, in the example shown in FIG. 12, a value “0.1” representing the magnitude of the “flash”, which is already input, is also displayed. These values may be set in advance by the user or the like as relative values representing the degree of the event corresponding to each item. A threshold, which indicates the boundary between a non-defective product and a defective product, may be set with respect to these values. For example, the threshold may be set to “1.0” for the “sink mark”, and when the value, which is input to the character input field 342 as shown in FIG. 12, is “1.5” which is larger than the threshold “1.0”, the molding product may be determined to be a defective product.

The input screens 330 and 340 shown in FIGS. 11 and 12 are configured separately from the input screens 310 and 320 described with reference to FIGS. 5 to 10. The display of the input screens 330 and 340 is performed, for example, under the control of the display control unit 260 of the data processing device 200 on a condition that the switching operation of the screen is performed on the input screens 310 and 320. For example, on the input screens 310 and 320, the switching operation is performed by operating a mouse as the input device 405, placing the mouse pointer over the item for which the character input is to be performed, and clicking the mouse button.

In addition, in the above example, although the input screens 330 and 340 that receive the character input are configured separately from the input screens 310 and 320 described with reference to FIGS. 5 to 10, the input screens 330 and 340 may be configured to receive the character input in the input screens 310 and 320. In this case, for example, a text box for performing the character input can be displayed in the vicinity of the selected item under a condition that a selection operation is performed on the item for which the character input is to be performed. For example, the selection operation of the item can be performed by operating a mouse as the input device 405, placing the mouse pointer over the item for which the character input is to be performed, and clicking the mouse button.

For example, the input of the command or the value by the user's voice is implemented by providing the data processing device 200 with a function of receiving the input through the voice and connecting a microphone as an acquisition unit of the voice. The reception of the input through the voice is implemented, for example, by the processing unit 220 executing a voice analysis through the program control. When a command or a value is input through the voice, the information or the command may be pronounced in accordance with a predetermined format or may be input through free speech. In the latter case, the information or the command can be extracted from the pronounced voice through a natural language analysis. When it is possible to receive voice input of the command and the value, the user can input the molding quality information, which is obtained by the measuring instrument, while performing an operation or the like of the measuring instrument to obtain the molding quality of the molding product without taking the user's hands off the measuring instrument.

In the present embodiment, each input unit, which includes the input screens 310 and 320, has been described assuming that each input unit is used to input the molding quality information to obtain the molding condition. However, these input units can be used in the control device 100 or the data processing device 200 as a unit that inputs the molding quality information as a processing target in various processes. For example, these input units may be used to input the molding quality information as training data in order to generate a mathematical model representing a relationship between the actual data and the molding quality to predict the molding quality based on the actual data related to the manufacturing of the molding product. The actual data includes the molding condition, which is set in the control device 100, or observation data such as a pressure waveform that is obtained from the injection unit 20 and the mold clamping unit 30 in the manufacturing process. In this case, when the user inputs the molding quality information on the manufactured molding product by using the input screens 310 and 320, and the like, the input molding quality information and the actual data, which is acquired during the manufacturing of the molding product, are associated and stored as the training data. By adopting such a configuration, it is possible to input the molding quality information immediately after the molding product is obtained and to obtain the training data. For this reason, after the molding work is completed, as in the case of generating the training data by associating log data for each shot obtained during the molding with the quality information on the molding product of the corresponding shot, there is no need to manage the shot for generating the training data, and the time required to generate the training data after the molding is completed is shortened. Furthermore, each input unit, which includes the input screens 310 and 320, may be used to input the molding quality information as the training data in order to generate a mathematical model representing a relationship between the molding quality and the molding condition used to estimate the molding condition in the molding condition estimation unit 240.

Although the embodiments of the present invention have been described above, the technical scope of the present invention is not limited to the above-described embodiments. For example, in the above-described embodiment, although the data processing device 200 generates the input screens 310, 320, 330, and 340 via the display control unit 260 and displays the input screens on the display device 300, which is connected to the data processing device 200, a configuration may also be adopted in which the information processing device, which is provided separately from data processing device 200, controls the display of the input screens 310, 320, 330, and 340 and receives the input. Specifically, the display of the input screens 310, 320, 330, and 340 and the reception of the input may also be implemented by providing information equipment, which includes a personal computer, a tablet information terminal, a smartphone, or other display units, with the functions of the display device 300 and the display control unit 260. In addition, various changes or alternatives in the configuration that do not depart from the scope of the technical thought of the present invention are included in the present invention.

It should be understood that the invention is not limited to the above-described embodiment, but may be modified into various forms on the basis of the spirit of the invention. Additionally, the modifications are included in the scope of the invention.

What is claimed is:

1. An information processing device comprising:
a display control unit that displays on a display device an input screen for inputting information related to a quality of a molding product manufactured by an injection molding machine;
a receiving unit that receives an operation performed on the input screen; and
a generation unit that generates the information related to the quality of the molding product according to the operation received by the receiving unit, wherein
the input screen is a screen that includes a predetermined item, which is the information related to the quality of the molding product and that displays a content for each item in a graph, and
on the input screen, the content displayed in the graph is changed according to the operation received by the receiving unit.

2. The information processing device according to claim 1, wherein
the item, which is shown in the graph on the input screen, is an item predetermined as input information to be input to an estimation unit that estimates, from the information related to the quality of the molding product, a molding condition required to obtain the quality.

3. The information processing device according to claim 1, wherein
the display control unit displays a reference image representing a reference at which the molding product is determined to be a non-defective product on the corresponding item for each of the items, in the graph on the input screen.

4. The information processing device according to claim 3, wherein
the reference image, which is displayed in the graph on the input screen, includes an image indicating a range where the molding product is determined to be a non-defective product, regarding the item for which the range is specified.

5. The information processing device according to claim 4, wherein
the display control unit displays, among the items for which the range displayed in the graph on the input screen is specified, an item which is included in the range where a value that is specified through the operation received by the receiving unit is determined to be a non-defective product and other items in a distinguishable manner.

6. The information processing device according to claim 3, wherein
the reference image, which is displayed in the graph on the input screen, includes an image indicating a boundary between a non-defective product and a defective product for the molding product, regarding the item for which the boundary is specified.

7. The information processing device according to claim 6, wherein
the display control unit displays, regarding the item for which the boundary displayed in the graph on the input screen is specified, a region on a side where the molding product is determined to be a non-defective product and a region on a side where the molding product is determined to be a defective product in a distinguishable manner with respect to the boundary.

8. The information processing device according to claim 3, wherein
the display control unit displays an image indicating a range where the molding product is determined to be a non-defective product, regarding the item for which the range is specified, and displays an image indicating a boundary between a non-defective product and a defective product for the molding product, regarding the item for which the boundary is specified, as the reference image.

9. The information processing device according to claim 1, wherein
the display control unit displays a character input field for inputting values with respect to at least some of the items, on the input screen that displays the graph or on another input screen that is different from the corresponding input screen.

10. The information processing device according to claim 9, wherein
the display control unit displays, in response to an operation of designating the item displayed in the graph on the input screen, the character input field for the designated item on the input screen.

11. The information processing device according to claim 9, wherein
the display control unit switches, in response to an operation of designating the item displayed in the graph on the input screen, a display to the other input screen including the character input field for the designated item.

12. The information processing device according to claim 9, wherein
the display control unit changes the content displayed in the graph based on the value input to the character input field.

13. The information processing device according to claim 1, further comprising:
a voice input unit that receives a voice input related to at least some of the items displayed in the graph on the input screen.

14. A non-transitory computer readable medium storing a program that causes a computer to realize:
a function of displaying on a display device an input screen for inputting information related to a quality of a molding product manufactured by an injection molding machine;
a function of receiving an operation performed on the input screen; and
a function of generating the information related to the quality of the molding product according to the operation received by using the function of receiving, wherein
in the function of displaying on the display device the input screen,
a screen that includes a predetermined item, which is the information related to the quality of the molding product, and that displays a content for each item in a graph is displayed, and
the content displayed in the graph is changed according to the operation performed on the input screen.
